(19) United States
(12) Patent Application Publication
(10) Pub. No.: US 2016/0324172 A1
(43) Pub. Date: Nov. 10, 2016

(54) Post-Harvest Coating for Fresh Produce

(71) Applicant: Jones-Hamilton Co., Walbridge, OH (US)

(72) Inventors: Patrick Williams, Kansas City, MO (US); Madeleine Eriksson Pate, Roeland Park, KS (US); Carl J. Knueven, Bowling Green, OH (US)

(73) Assignee: Jones-Hamilton Co., Walbridge, OH (US)

(21) Appl. No.: 15/146,068

(22) Filed: May 4, 2016

Related U.S. Application Data
(60) Provisional application No. 62/156,351, filed on May 4, 2015.
(60) Provisional application No. 62/196,959, filed on Jul. 25, 2015.

(51) Int. Cl. A23B 7/155; A23L 3/3562; A23L 3/358; A01N 59/02; A01N 43/16

(52) U.S. Cl. CPC A23B 7/155; A01N 59/02; A01N 43/16; A23L 3/358; A23L 3/3562; A23V 2002/00

(57) ABSTRACT

An antimicrobial coating material for post-harvest coating of produce includes a mixture of an acid component and a film-forming carbohydrate. A method for post-harvest treatment of produce includes applying a coating material onto produce after harvest and cleaning, thereby producing an antimicrobial coating in the form of an encapsulating film on the surface of the produce. A method for inactivating microbial spores on produce includes applying a coating material onto produce after harvest and cleaning, thereby producing an antimicrobial coating that is effective to inactivate microbial spores on the produce.

### CROSS-REFERENCE TO RELATED APPLICATIONS

This application claims the benefit of U.S. Provisional Application No. 62/156,351, filed May 4, 2015, and U.S. Provisional Application No. 62/196,959, filed Jul. 25, 2015, the disclosures of which are incorporated herein by reference.

### BACKGROUND OF THE INVENTION

This invention relates in general to compositions and methods for the treatment of foods, and in particular for the treatment of produce to reduce post-harvest losses.

The loss of food produced but never consumed by humans is enormous both in developed and developing countries and has far-reaching implications on economies, the environment and global food security. Fruits and vegetables are a highly perishable crop often produced and consumed at different sites. In an increasingly global food supply chain, produce is required to travel longer distances to reach the end consumer or processing facility, and needs to withstand deterioration more efficiently to remain intact throughout the distribution network.

In the United States about 50% of the food supply is never eaten. This is among the highest rates of food loss globally. The USDA estimates that supermarkets lose $15 billion annually in unsold fruits and vegetables. Worldwide, about one third of horticultural crops are lost forever. This inefficiency has high socio-economic costs and wastes limited resources such as water, energy and arable land.

The reduction of post-harvest losses is therefore a key element in improving the sustainability of the fresh produce supply chain and in securing its affordability and availability on the market. If 30% of US food loss were redistributed, it could provide the total diet for nearly 50 million people, the number of Americans living in food insecure households. This is particularly important as the world population is growing and demanding more and a wider selection of produce year-round, while at the same time many produce-growing regions, such as the U.S. Southwest, are observing an unfavorable climate shift towards more severe droughts and water shortage, impeding the cultivation of produce.

Reducing food waste is considered to be one of the most promising measures to improve food security in coming decades. Approximately 25% of the produced food is lost within the food supply chain. Some post-harvest loss is inevitable due to shrinkage, water (weight) loss, physiological deterioration processes, pests, weather conditions, physical damage, spoilage, removal of peel and seeds, and because a certain amount generally needs to be discarded to ensure the quality and safety of the rest. Spoilage, however, is a consistent and substantial contributor to post-harvest losses of fresh produce and occurs in all regions of the world and at all stages of the value chain. According to a study by the USDA ERS in 1995, 18.9 billion pounds of fresh fruits and vegetables were lost annually in the United States due to spoilage. The loss of produce accounted for 19.6% of all US losses of edible foods, which was higher than for any other commodity.

Although the produce industry already utilizes a variety of methods and continues to implement stricter hygienic practices to their operations, clearly, further innovation is needed to improve produce stability and to reduce the enormous post-harvest losses of produce. The difficulty with post-harvest management of produce is to treat the perishable commodity enough to make it stable and safe for transportation, storage and consumption but to also limit the treatment and packaging since consumers demand fresh and minimally processed produce with a natural appearance.

In the fruit and vegetable product industry, two principle approaches are currently being used to wash raw produce: chlorine based washes and peracetic acid/hydrogen peroxide based washes. These washing materials are commonly used to remove soil, debris, and microbes such as bacteria and mold from produce. While these products provide some level of cleaning and decontamination of fresh fruits and vegetables, they provide no extended protection of the produce to recontamination with food spoilage organisms and pathogens as the produce enters the food supply chain.

Therefore, it would be desirable to provide an improved composition and method for the treatment of produce to reduce post-harvest losses.

### SUMMARY OF THE INVENTION

This invention relates to an antimicrobial coating material for post-harvest coating of produce. The coating material comprises a mixture of an acid component and a film-forming carbohydrate.

In another embodiment, the invention relates to a method for post-harvest treatment of produce. The method comprises applying a coating material onto produce after harvest and cleaning, thereby producing an antimicrobial coating in the form of an encapsulating film on the surface of the produce. The coating material comprises a mixture of an acid component and a film-forming carbohydrate.

In a further embodiment, the invention relates to a method for inactivating microbial spores on produce. The method comprises applying a coating material onto produce after harvest and cleaning, thereby producing an antimicrobial coating in the form of an encapsulating film on the surface of the produce. The coating material is effective to inactivate microbial spores on the produce.

Various aspects of this invention will become apparent to those skilled in the art from the following detailed description of the preferred embodiment, when read in light of the accompanying drawings.

### BRIEF DESCRIPTION OF THE DRAWINGS

FIG. 1 shows graphs of the inhibition of microorganisms on cantaloupes using the post-harvest coating of the invention.

FIG. 2 is a graph of the inhibition of microorganisms on grape tomatoes using the post-harvest coating of the invention.

FIG. 3 shows graphs of the reduction of Listeria on cantaloupes using the post-harvest coating of the invention

FIG. 4 shows graphs of the reduction of Salmonella on produce, the post-harvest coating of the invention by soaking, dipping and spraying.

FIG. 5 shows graphs of the inhibition of cross-contamination on produce using the coating of the invention.

FIG. 6 shows graphs of the microbial load on grape tomatoes coating with three different coating materials.

FIG. 7 shows graphs of sensory panel results concerning produce treated with the coating of the invention.

FIG. 8 is a graph of measurements of inhibition zones generated by the coating of the invention.

FIG. 9 is a graph of the inhibition of spores by three coating solutions according to the invention.

FIG. 10 is a graph of the inhibition zone of Salmonella using the coating of the invention.

FIG. 11 is a graph of microbial inhibition using a coating according to the invention including sodium acid sulfate, peracetic acid and chitosan.

### DETAILED DESCRIPTION OF THE PREFERRED EMBODIMENT

Since the recontamination of produce after a sanitation step cannot be prevented entirely, the present invention changes the surface properties of fresh produce to create an environment that is inhibitory to most microbial life. This modification is accomplished by a post-harvest treatment, which encapsulates the individual fruits and vegetables with a protective pH-lowering coating. The coating adds another physicochemical hurdle for spoilage organisms that reduce the shelf life of fresh produce, and pathogenic microbes that can cause foodborne illness.

The technology is based on a formulation including an acid component, a film-forming carbohydrate and a surfactant/emulsifier. By combining the acid component with the carbohydrate and the surfactant/emulsifier, an antimicrobial film can be formed on the produce surface. The antimicrobial coating material can be applied on freshly harvested produce to reduce postharvest losses.

While not intending to be limited by theory, the mechanism of the antimicrobial produce coating is believed to be based on the reduction in pH and the continuous presence of a pH agent on the produce surface which injures and/or challenges microbial cells coming in contact with the material. The degree of this damage or inhibition varies depending on the organisms' sensitivity to low pH and other factors that can support or suppress the growth and survival of cells.

The coating is applied onto the produce after harvest and cleaning procedures, creating a thin and even layer. It protects the produce during transportation, storage and distribution, until it arrives at the final retail store where the coating, although edible, can be washed off to meet consumer preferences.

The purpose of the treatment is to increase the shelf life and stability of perishable produce and thereby reduce the amount of losses that generally occur between farm and consumer. Furthermore, the coating can inhibit the growth and spread of pathogens in the produce supply chain and thus help to protect the commodity from forwarding health hazards to the consumers.

The antimicrobial coating material comprises a mixture of an acid component, a film-forming carbohydrate and a surfactant/emulsifier. In certain embodiments, one or more of the components in the coating are food grade, and in some embodiments they are all food grade. In certain embodiments, the surfactant/emulsifier is optional. In some cases, the coating material further comprises a thickener/stabilizer or other materials. Following are nonlimiting examples of ingredients that can be used in formulations of the coating material in some embodiments. Additional types of suitable acids are described in the paragraphs below.

Organic acids: citric acid, lactic acid, sorbic acid, benzoic acid, formic acid, propionic acid, malic acid, acetic acid, peracetic acid, tartaric acid, and fumaric acid.

Surfactants/emulsifiers: glycerin, lecithins, mono- and diglycerides of fatty acids (MDG), esters of mono- and diglycerides of fatty acids (for example, acetic acid esters of mono- and diglycerides of fatty acids (ACETEM), lactic acid esters of mono- and diglycerides of fatty acids (LACTEM), citric acid esters of mono- and diglycerides of fatty acids (CITREM), tartaric acid esters of mono- and diglycerides of fatty acids, and mono- and diacetyl tartaric acid esters of mono- and diglycerides of fatty acids (DATEM)), sucrose esters of fatty acids, polyglycerol esters of fatty acids, polyglycerol polyricinoleate (PGPR), propylene glycol esters of fatty acids, methyl cellulose, ethyl cellulose, hydroxypropyl cellulose, sodium stearoyl lactylate (SSL), calcium stearoyl lactylate (CSL), and Polysorbate 20.

Thickeners/stabilizers: xanthan gum, guar gum, pectin, modified tapioca starch, methyl cellulose, ethyl cellulose, hydroxypropyl cellulose.

Carbohydrates/plant starches: cornstarch, potato starch, rice starch, wheat starch, and tapioca starch.

Modified plant starches: chemically modified starches, and heat treated starches.

The acid component can comprise an inorganic acid, an organic acid, or a salt of an acid. Combinations of different acids or their salts can also be used. In certain embodiments, the acid is a food grade acid.

Any suitable inorganic acid or organic acid can be used. Some examples of inorganic acids that may be used include sulfuric acid, hydrochloric acid, phosphoric acid, sulfamic acid, nitric acid and hydrofluoric acid. Some examples of organic acids that may be used include those listed above (citric acid etc.) and others.

Any suitable salts of acids can be used. In certain embodiments, these are alkali metal salts or alkaline earth metal salts of inorganic acids, such as sulfates, phosphates or nitrates. The salts of inorganic acids convert to acids when hydrated with sufficient water. Some examples of alkali metals include sodium, potassium and lithium, and some examples of alkaline earth metals include calcium and magnesium. In certain embodiments, the metal salts are alkali metal bisulfates which include, for example, sodium bisulfate (i.e., sodium acid sulfate or sodium hydrogen sulfate), potassium bisulfate (i.e., potassium acid sulfate or potassium hydrogen sulfate), or mixtures thereof. In other embodiments, the metal salts are calcium bisulfate or magnesium bisulfate.

Food grade sodium acid sulfate is manufactured and sold as pHase™ by Jones-Hamilton Co. in Walbridge Ohio. It has been certified as GRAS (Generally Recognized As Safe), and it meets Food Chemicals Codex, 5th Edition Specifications. The sodium acid sulfate is in dry granular crystalline form in particle sizes that can be readily and uniformly dispersed and solubilized in aqueous media. In certain embodiments, the particles having a generally spherical shape with an average diameter from about 0.03 mm to about 1 mm, typically about 0.75 mm. Also, in certain embodiments, the product includes sodium bisulfate in an amount from about 91.5% to about 97.5% by weight (typically about 93%), and sodium sulfate in an amount from about 2.5% to about 8.5% by weight (typically about 7%).

In certain embodiments, the coating may also include an oxidizer. For example, the oxidizer may be hydrogen peroxide, peroxyacetic acid, or a combination of these materials. A combination of an oxidizer with the acid component can be effective at reducing microbes without adversely affecting the qualities of the produce. The oxidizer can be included in any suitable amount, for example an amount within a range of from about 10 ppm to about 2500 ppm of the coating.

The film-forming carbohydrate can be any type of carbohydrate that, when combined with the acid component, is suitable for producing a coating in the form of an encapsulating film on the surface of the produce. Combinations of different carbohydrates can also be used. In some preferred embodiments, the carbohydrate has one or more of the following characteristics: film-forming and easy to apply, food grade and biological, water-soluble and washable, safe and easy to handle, cost-effective and abundant, free of common allergens, biodegradable and environmentally friendly, and odorless, tasteless and colorless.

For instance, in certain embodiments, the film-forming carbohydrate is a plant starch. Some examples of plant starches include cornstarch, potato starch, rice starch, wheat starch and tapioca starch. In certain embodiments, the starch is chemically modified or heat treated to make the starch more water-soluble and/or to improve film-forming properties.

Any suitable surfactant/emulsifier can be used. Some nonlimiting examples of surfactants/emulsifiers are disclosed in the above list.

A number of other materials may optionally be used in the coating material. Some examples are disclosed in the above lists.

The acid component, film-forming carbohydrate and surfactant/emulsifier can be included in any suitable amounts in the coating material. In certain embodiments, the coating material comprises the acid component in an amount from about 1 wt % to about 15 wt %, the film-forming carbohydrate in an amount from about 1 wt % to about 20 wt %, and the surfactant/emulsifier in an amount from about 0.001 wt % to about 5 wt %. In some examples, the coating material comprises the acid component in an amount from about 1 wt % to about 7 wt %, the film-forming carbohydrate in an amount from about 5 wt % to about 15 wt %, and the surfactant/emulsifier in an amount from about 0.04 wt % to about 2 wt %.

In certain embodiments, the coating material further comprises water to produce an aqueous solution of the acid component, the film-forming carbohydrate and the surfactant/emulsifier. The components are mixed into the solution by any suitable means. The aqueous solution is applied onto the produce and the water evaporates leaving an encapsulating film on the produce surface. Any suitable amount of water can be used in the coating material, and the amount may depend on the particular ingredients and the method of applying the coating material. In certain embodiments, the coating material comprises water in an amount from about 60 wt % to about 98 wt % and the total of the film-forming carbohydrate, the acid component and the surfactant/emulsifier in an amount from about 2 wt % to about 40 wt %.

The coating material can be applied to the produce by any suitable method. For example, when the coating material is applied as an aqueous solution, it may be applied by soaking, dipping or spraying the produce. The applied coating adheres to the surface of the produce and is stable enough to remain intact on the surface for at least several days.

By “produce” is meant fruits and vegetables. Some nonlimiting examples are tomatoes, cantaloupes, peppers, avocados and others well known in the food and agriculture industries.

The antimicrobial coating material can provide certain advantage(s). The coating material can provide a post-harvest treatment that is economical, convenient, safe and easy to use. The new product can be designed to fit into existing equipment and operation processes so that it can quickly and smoothly be implemented into small and large scale productions, without requiring extensive extra costs or replacement of equipment. The ingredients used for the new formulation can be cheap, abundant, and readily available on the market with very high consistency in quality and functionality. The product can be an affordable and practical solution for farmers, packagers and distributors. This product can reduce food loss and waste throughout the distribution chain and offer new solutions to alleviate hunger, support efficient resource management, and maximize financial benefits through improved product management.

In certain embodiments, the coating material is effective to inactivate microbial spores on the produce. The coating may be effective to inhibit germination of spores, vegetative cycle of spores, and sporulation. The coating may be effective to inactivate microbial spores within about 5 minutes of coating the produce. Additional details are provided below in Experiment 3.

### Experiment 1

### Abstract

In a first experiment, the sodium acid sulfate was combined with a carbohydrate (cornstarch) to form a post-harvest coating material with the ability to adhere to the surface of fresh produce, where it reduced the presence and growth of microorganisms. Produce studied included grape tomatoes and cantaloupes. The coating material was effective in inhibiting microorganisms, including molds, yeasts, and bacteria, naturally occurring on fresh produce purchased at retail level; and pathogenic bacteria (Listeria monocytogenes and Salmonella spp.) on inoculated produce items. The obtained reduction in microorganisms ranges from 1-7 log units CFU/ml.

Hypothesis

It is possible to combine sodium acid sulfate with a carbohydrate to form a coating material with the ability to form a film on the surface of fresh produce.

A coating solution consisting of sodium acid sulfate and a carbohydrate can reduce the amount of microorganisms (both spoilage organisms and pathogenic bacteria) on the surface of treated produce.

The coating material is stable enough to remain intact on the produce surface for several days, even under challenging conditions (such as high humidity).

Summary

Film-Forming Carbohydrates

Three materials (cornstarch, potato starch, white rice flour) were studied for their suitability as a film-forming component in the coating formulation. Cornstarch was found to give the best and most uniform and consistent coatings. Potato starch did not demonstrate the same stickiness and resulted in a thinner layer. White rice flour was coarser and less preferred. White rice starch, not included in this study, might still be considered for future coating formulation experiments.

Shelf Life/Quality

Fresh produce has generally a short shelf life due to its high perishability. Metabolic deterioration, microbial spoilage, and susceptibility to physical injury are main contributors to rapid quality decline, causing huge losses between farm and consumer.

The post-harvest coating has a significant inhibitory effect on various microorganisms (molds, yeasts, and bacteria), including spoilage organisms. With its ability to reduce the presence and growth of microorganisms, the coating can contribute to a reduction in post-harvest losses that are attributed to microbial spoilage during storage and distribution.

Inhibition of Naturally Occurring Microorganisms

Table 1 below shows the post-harvest coating's ability to inhibit naturally occurring microorganisms on cantaloupes and grape tomatoes.

TABLE 1
Number of CFU/ml (and CFU/cantaloupe) and reduction of naturally occurring microorganisms on
coated and non-coated (control) cantaloupes and grape tomatoes, after 7 days of incubation
CANTALOUPES

| | Day 0 | | Day 1 | | Day 3 | | Day 7 | |
|---|---|---|---|---|---|---|---|---|
| | Control | Coated | Control | Coated | Control | Coated | Control | Coated |
| CFU/ml | 1,500 | 83 | 1,000 | 0 | 80,667 | 167 | 86,833 | 333 |
| Reduction | 2 | | 3 | | 2 | | 2 | |
| (log units | | | | | | | | |
| CFU/ml) | | | | | | | | |
| Reduction | 94.5% | | 100.0% | | 99.8% | | 99.6% | |
| (%/ml) | | | | | | | | |
| CFU/melon | 24,000 | 1,333 | 16,000 | 0 | 1,290,667 | 2,667 | 1,370,666,667 | 5,333 |

| | | | | |
|---|---|---|---|---|
| Reduction | 1 | 4 | 3 | 6 |
| (log units | | | | |
| CFU/melon) | | | | |
| Reduction | 94% | 100.00% | 99.79% | 99.99961% |
| (%/melon) | | | | |

GRAPE TOMATOES

| | Day 0 | | Day 1 | | Day 3 | | Day 10 | |
|---|---|---|---|---|---|---|---|---|
| | Control | Coated | Control | Coated | Control | Coated | Control | Coated |
| CFU/ml | — | — | 317 | 28 | 333,700 | 66 | 333,418 | 80 |

| | | | | |
|---|---|---|---|---|
| Reduction | — | 1 | 4 | 4 |
| (log units | | | | |
| CFU/ml) | | | | |
| Reduction | — | 91% | 99.980% | 99.998% |
| (%/ml) | | | | |

The post-harvest coating was demonstrated to reduce 94-100% of microorganisms naturally occurring on fresh whole cantaloupes, and 91-99.998% of microorganisms naturally occurring on fresh grape tomatoes.

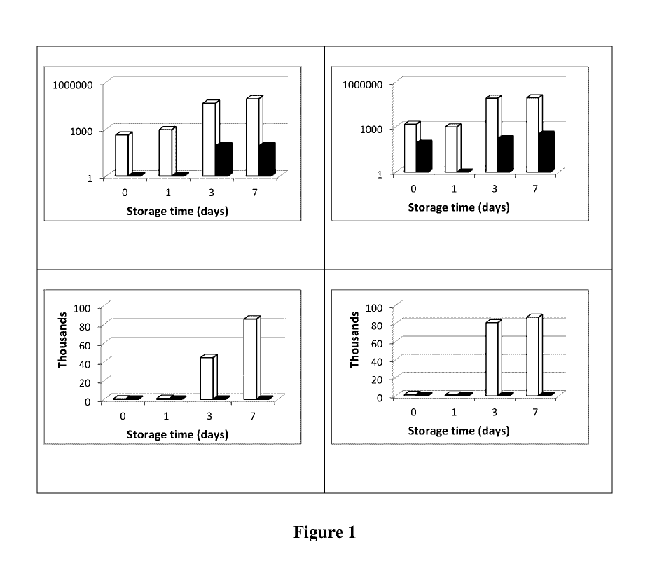

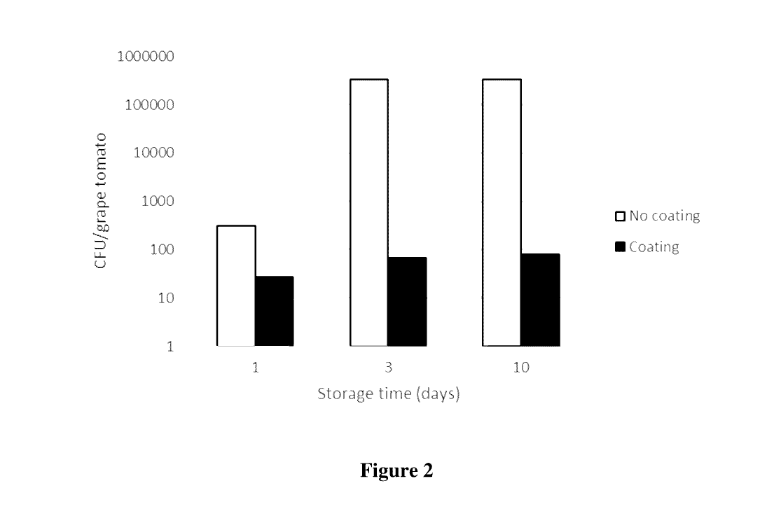

FIG. 1 and FIG. 2 attached show the reduction in microorganisms in graphical form.

Inhibition of Listeria monocytogenes

Table 2 below shows the post-harvest coating's reduction of Listeria monocytogenes on cantaloupes and grape tomatoes.

TABLE 2
Number of CFU/ml (and CFU/cantaloupe) and reduction of Listeria monocytogenes and
other organisms on coated and non-coated (control) cantaloupes and grape tomatoes.
CANTALOUPES (*)

| | Day 0 | | Day 1 | | Day 3 | | Day 7 | |
|---|---|---|---|---|---|---|---|---|
| | Control | Coated | Control | Coated | Control | Coated | Control | Coated |
| CFU/ml | 1,668,083 | 0 | 84,417,083 | 500 | 333 | 0 | 17,583 | 167 |
| Reduction | 6 | | 5 | | 2 | | 2 | |
| (log units | | | | | | | | |
| CFU/ml) | | | | | | | | |
| Reduction | 100.0000% | | 99.9994% | | 100% | | 99.1% | |
| (%/ml) | | | | | | | | |
| CFU/melon | 26,689,333 | 0 | 1,334,673,333 | 8,000 | 5,333 | 0 | 281,333 | 2,667 |

| | | | | |
|---|---|---|---|---|
| Reduction | 7 | 6 | 3 | 2 |
| (log units | | | | |
| CFU/melon) | | | | |
| Reduction | 100.00000% | 99.99940% | 100.0% | 99.1% |
| (%/melon) | | | | |

GRAPE TOMATOES (**)

| | Day 0 | | Day 3 | | Day 6 | | Day 9 | |
|---|---|---|---|---|---|---|---|---|
| | Control | Coated | Control | Coated | Control | Coated | Control | Coated |
| CFU/ml | 195 | 526 | 10⁶ | 0 | 10⁶ | 36 | 10⁶ | 26 |

| | | | | |
|---|---|---|---|---|
| Reduction | — | 6 | 5 | 5 |
| (log units CFU/ml) | | | | |
| Reduction | — | 100.0000% | 99.9964% | 99.9974% |
| (%/ml) | | | | |

(*) after 7 days of incubation
(**) after 1 day of incubation

The post-harvest coating was demonstrated to reduce 99.1-100% of Listeria monocytogenes on adulterated cantaloupes and 99.9-100% on adulterated grape tomatoes.

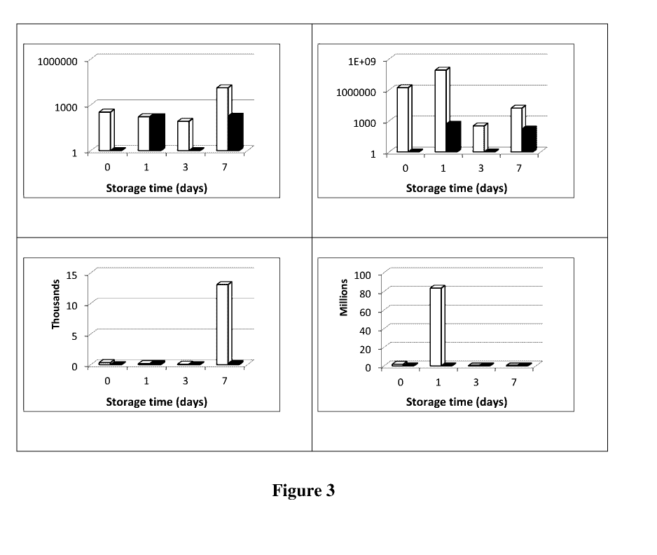

FIG. 3 attached shows the reduction of Listeria monocytogenes in graphical form.

Inhibition of Salmonella spp.

Table 3 below shows that the post-harvest coating was demonstrated to reduce 90-99.988% of Salmonella spp. on fresh grape tomatoes.

TABLE 3
Number of CFU/ml and reduction of Salmonella spp. and other organisms on
coated and non-coated (control) grape tomatoes, after 7 days of incubation
Grape tomatoes

| | Day 0 | | Day 3 | | Day 6 | | Day 9 | |
|---|---|---|---|---|---|---|---|---|
| | Control | Coated | Control | Coated | Control | Coated | Control | Coated |
| CFU/ml | 1,000 | 8 | 467 | 17 | 667,000 | 78 | 786 | 17 |

| | | | | |
|---|---|---|---|---|
| Reduction | 3 | 1 | 4 | 1 |
| (log units | | | | |
| CFU/ml) | | | | |
| Reduction | 99.20% | 90% | 99.988% | 98% |
| (%/ml) | | | | |

Soaking vs. Dipping vs. Spraying

If grape tomatoes were dipped for 5 seconds into the coating solution (instead of soaked for 1 minute), the reduction in Salmonella spp. was identical (90-99.9859%). If sprayed with the coating solution, the reduction of Salmonella spp. was still significant but somewhat lower, ranging from 68-99.951%. The results are shown in Table 4 below:

TABLE 4
Number of CFU/ml and reduction of Salmonella spp. and other organisms
on coated and non-coated (control) grape tomatoes. Coating was applied
via a 1-minute soak, 5 seconds dip or through spraying.

| Day 0 | | Day 3 | | Day 6 | | Day 9 | |
|---|---|---|---|---|---|---|---|
| Control | Coated | Control | Coated | Control | Coated | Control | Coated |

1 min soak(*)

| | | | | | | | | |
|---|---|---|---|---|---|---|---|---|
| CFU/ml | 1,000 | 8 | 467 | 17 | 667,000 | 78 | 786 | 17 |

| | | | | |
|---|---|---|---|---|
| Reduction | 3 | 1 | 4 | 1 |
| (log units | | | | |
| CFU/ml) | | | | |
| Reduction | 99.20% | 90% | 99.988% | 98% |
| (%/ml) | | | | |

5 sec dip (*)

| | | | | | | | | |
|---|---|---|---|---|---|---|---|---|
| CFU/ml | 1,000 | 17 | 467 | 48 | 667,000 | 94 | 786 | 54 |

| | | | | |
|---|---|---|---|---|
| Reduction | 2 | 1 | 5 | 1 |
| (log units | | | | |
| CFU/ml) | | | | |
| Reduction | 98.3% | 90% | 99.9859% | 93% |
| (%/ml) | | | | |

Spray (*)

| | | | | | | | | |
|---|---|---|---|---|---|---|---|---|
| CFU/ml | 1,000 | 11 | 467 | 62 | 667,000 | 328 | 786 | 254 |

| | | | | |
|---|---|---|---|---|
| Reduction | 2 | 1 | 3 | 1 |
| (log units | | | | |
| CFU/ml) | | | | |
| Reduction | 98.9% | 87% | 99.951% | 68% |
| (%/ml) | | | | |

(*) after 7 days of incubation

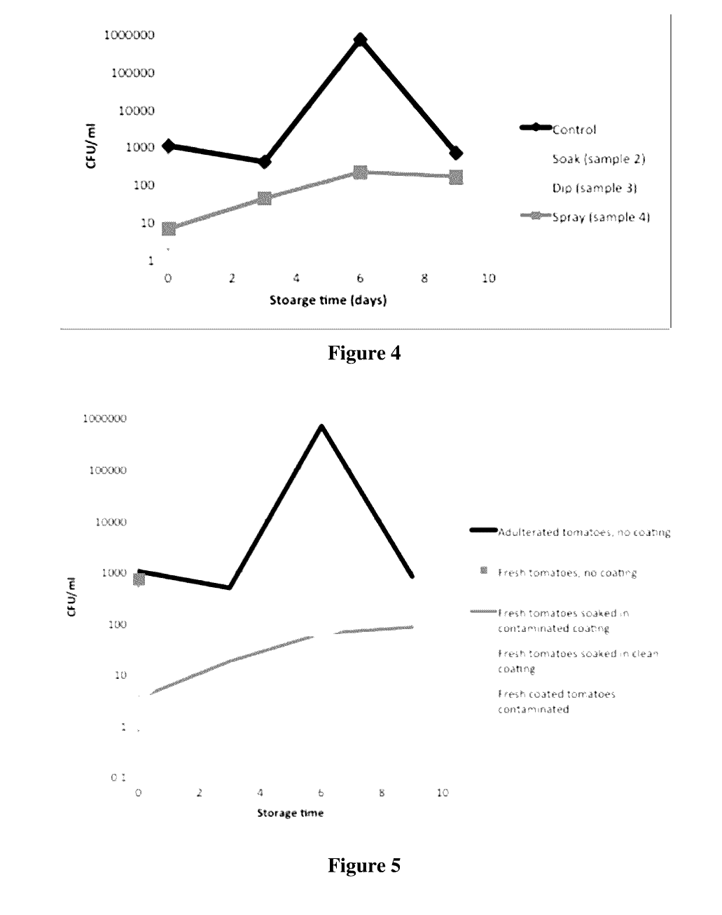

FIG. 4 attached shows the results of soaking vs. dipping vs. spraying in graphical form.

Inhibition of Cross-Contamination

The coating material (both as solution and as a dry layer on the produce surface) was shown to reduce cross-contamination on grape tomatoes. FIG. 5 attached shows the inhibition of cross-contamination in graphical form.

Salmonella-adulterated grape tomatoes were soaked in a coating solution. Thereafter, fresh grape tomatoes (not adulterated) were soaked in the Salmonella-contaminated coating solution. The coating solution reduced the number of naturally occurring microorganisms on the fresh tomatoes (by 3 log units CFU/ml), but also limited the spread of viable Salmonella cells from the contaminated coating solution to the non-adulterated grape tomatoes, and inhibited the growth of Salmonella cells both in the solution and on the coated tomato surface. No colony forming units were found in samples collected from the contaminated coating solution. On the coated tomato surface microbial growth was limited to 1-2 log units CFU/ml over 9 days of storage at room temperature.

Secondly, fresh grape tomatoes (not adulterated) were coated and dried, and then contaminated with a drop of Salmonella solution. Again, growth of Salmonella cells was limited by the presence of the dry coating (to 1-2 log units CFU/ml over 9 days of storage at room temperature).

Humidity

Coated vine tomatoes were placed into a humidity chamber and subjected to high and cycling humidity for a period of 24 hours. The coating soaked up moisture from the saturated air at high humidity but dried quickly if humidity was decreased again. The humidity challenge did not remove or disintegrate the coating, neither at 99% humidity nor after several cycles. The material proved very stable.

Conclusions

A combination of sodium acid sulfate, cornstarch, and surfactants can form a coating material with the ability to stick to the surface of fresh produce (grape tomatoes and cantaloupes).

A coating solution consisting of sodium acid sulfate and cornstarch can inhibit spoilage microorganisms and pathogenic bacteria (Listeria monocytogenes and Salmonella spp.) on the surface of treated produce, obtaining a reduction of 1-7 log units CFU/ml.

A produce coating with sodium acid sulfate and cornstarch showed high stability and remained intact on the produce surface over several days as well as under challenging conditions such as high and cycling humidity.

Further Work

A series of experiments may be conducted to further optimize the formulation of the coating material; including measurements of viscosity and flow characteristics, surface coating/binding, and microbial inhibition. A series of field studies may be conducted to evaluate the performance of the coating on fruits and vegetables moving through the supply chain. Using freshly harvested, cleaned and sorted produce, the coating material may be applied according to standard operating procedures. Coated and non-coated (control) samples of produce may be placed into and tracked through the food supply chain for transportation to a distribution terminal. Upon arrival, the control and treated produce may be evaluated for overall quality, sensory attributes, and biological burden.

It is believed that the post-harvest coating formulation can be adjusted to provide optimum film-forming performance and optimum microbial control across a variety of produce crops. It is believed that field studies will confirm the ability of the post-harvest coating to control spoilage organisms and pathogens of concern, and thereby improve shelf life and quality for the produce. It is believed that a field study will provide additional information on the performance characteristics of the coating material over extended shipment time frames.

Optimization of the coating formulation may include the following actions. Study the film-forming properties of a coating formulation containing further colloidal ingredients (carbohydrates, gums, etc.) and mixtures of colloidal ingredients. Study the performance of a coating formulation containing different surfactants, focusing on food-grade and/or biological surfactants. Heat-treat starch to minimize any potentially present microorganisms and to modify the starch's water solubility and film-forming characteristics. Study viscoelastic properties and flow behavior of the coating solution.

Optimization of the coating formulation may include the following objectives. Improve formulation of coating material to enhance film-forming properties, stickiness, and anti-microbial effect. Design coating formulation strategically to achieve desired goals/purpose. Finalize product design and develop a marketable prototype that can be used for further study. Adapt coating formulation to the viscoelastic properties of the coating in solution to reduce risks of shear thickening behavior during up-scaling and bulk handling.

Protecting Produce from Biological Hazards

Introduction: Fresh produce, often consumed raw, has been repeatedly linked to foodborne illness and accounts for some of the most deadly outbreaks. Salmonella spp. (S. spp.) and Listeria monocytogenes (L. m.) are two of the most critical pathogens of concern for produce safety.

Purpose: The post-harvest treatment for fresh produce of the invention can help to protect the commodity from biological hazards during distribution. The purpose of this study was to explore the treatment's ability to reduce L. m. and S. spp. on fresh grape tomatoes.

Method: Fresh grape tomatoes (n=12) were soaked in a 10⁶ CFU/mL L. m. or S. spp. solution for one minute, air-dried, and then soaked in the treatment solution for one minute. Samples were air dried to allow the material to dry. Bacterial swabs (n=3) were collected from the tomatoes at day 0, 3, 6, and 9. All cultures were grown on nutrient agar and CFU's were enumerated at 24 hours. Plates were held for 7 days.

Results: Preliminary data suggests a clear trend towards a significant reduction in L. m. and S. spp. on treated tomatoes. Adulterated, non-treated tomatoes (control) showed confluent growth of pathogens for the majority of swabs during the 9-day sampling period, while treated tomatoes showed a 3-6 log CFU/mL reduction. Some swabs contained no visible colonies after 24 hours but started to grow up after 2-4 days. This demonstrates the treatment's inhibitory effect. Swabs from day 6 and day 9 grew less L. m. than swabs from day 3, but contained more molds.

Significance: The post-harvest treatment demonstrates the ability to reduce L. m. and S. spp. populations on the surface of fresh grape tomatoes and inhibits the pathogen's growth for several days. The treatment has also effectively been tested on adulterated cantaloupes.

### Experiment 2

### Summary

Several coating solutions were prepared using different emulsifying and stabilizing agents. Grape tomatoes were soaked and dried, and the various materials were evaluated in terms of their solubility in the coating solution, their adherence or stickiness to the tomato surface, the uniformity of the obtained coatings, and the antimicrobial properties of these coatings. Sucrose ester of fatty acids and Tween 20 gave best results.

Introduction

In one embodiment, the produce coating of the invention is made with a formulation that includes Dawn® dish soap (which contains sodium alcohol sulfates and sodium alcohol ethoxysulfates as surfactants). The purpose of this experiment is to find alternatives to the dish soap in the formulation by replacing it with other ingredients that are food-grade but show the same effect of overcoming the hydrophobicity of certain produce surfaces. For this purpose, grape tomatoes were treated with different coating solutions to compare the performance of selected materials including their solubility, film-forming properties and antimicrobial effect on naturally occurring microorganisms.

Materials and Methods

A current formulation of the post-harvest coating for fresh produce is: tap water, 7 w % SAS, 15 w % cornstarch, and 0.06 gram Dawn dish soap per gram cornstarch.

For this experiment, coating solutions consisted of: 200 g tap water, 14 g SAS (7 w %), 30 g cornstarch (15 w %), and varying amounts of diverse emulsifiers/stabilizers.

Emulsifying materials studied: Dawn® liquid dish soap, vegetable glycerin, fatty acid ester of mono- and diglycerides, soy lecithin, sucrose esters of fatty acids, methyl cellulose, pectin, and Tween 20.

Treatment: For each emulsifying material, one grape tomato was soaked for 1 minute in respective coating solution, and allowed to dry on a cooling tray. If material generated a visually preferred coating, 8 more grape tomatoes were coated (nₜₒₜₐₗ=9) in the same solution to generate enough samples for a microbial test. If the material did not stick to the tomato surface satisfactorily, more of the emulsifying agent was added to the coating solution in an attempt to improve stickiness. A second grape tomato was soaked, and if the stickiness improved, the concentration of the emulsifying ingredient was further increased until preferred coating was achieved. 8 more tomatoes were coated at preferred concentration (nₜₒₜₐₗ=9) for microbial testing. If an emulsifying agent did not form a preferred coating, even at increased concentrations, no microbial test was performed.

Evaluation: Coatings were photographed and evaluated visually after the material dried. Microbial test of tomatoes with preferred coatings: Grape tomatoes were stored for 7 days at room temperature on cooling trays. Three tomatoes (triplicates) were swabbed with pre-wetted cotton swabs after: 24 hours, 3 days and 7 days. For dilution purpose, the swabs were transferred to Eppendorf tubes with 1 ml PBS. Three 1 ul loops (triplicates) were used to transfer three 1 ul samples per Eppendorf tube to nutrient agar plates. Per swab: 1 Eppendorf tubes and 3 nutrient agar plates. Per tomato: 3 Eppendorf tubes and 9 nutrient agar plates. Nutrient agar plates were incubated at room temperature for 7 days. Colony forming units were counted after: 24 hours, 3 days and 7 days.

Experimental Overview

Table 5 below gives an overview of the emulsifying/stabilizing ingredients used to generate coatings in this experiment, and lists the amounts (g) of each emulsifying/stabilizing agent that was added to the coating solutions.

TABLE 5
Overview of emulsifying/stabilizing ingredients and amounts (g)
used of each of them to generate coatings in this experiment

| Emulsifying/Stabilizing | Initial | Added | |
|---|---|---|---|
| ingredient | amount (g) | amounts (g) | Comments |
| Dawn dish soap | 1.7 | 0 | Standard |
| | | | formulation |
| Vegetable glycerin | 1.7 | +1.7 | |
| | | +1.7 | |
| | | +31 | |
| | | +50 | |
| Fatty acid ester of | 1.7 | 0 | |
| mono-and diglycerides | | | |
| Soy lecithin | 1.7 | 0 | |
| Sucrose esters of | 1.7 | +1.7 | |
| fatty acids | | | |
| Methyl cellulose | 1.7 | 0 | |
| Pectin | 1.7 | +1.7 | |
| | | +1.7 | |
| | | +6 | |
| | | +10 | |
| Tween 20 | 0.1 | +0.3 | Too little |
| | | | was used |

Results—Visual Evaluation

Table 6 below gives an overview of the emulsifying/stabilizing ingredients used to generate coatings/coating solutions in this experiment and describes the observed quality of: the coating solutions in terms of emulsifier/stabilizer solubility; and the obtained dry coatings in terms of stickiness and film-forming properties.

TABLE 6
Visual evaluation of the coatings and coating solutions obtained
with different emulsifying/stabilizing ingredients

| | Coating solution | |
|---|---|---|
| Emulsifying/Stabilizing | (Solubility of | Dried coating |
| ingredient | emulsifier/stabilizer) | (Stickiness, film-forming properties) |
| Dawn liquid dish soap | Good | Uniform |
| Vegetable glycerin | Good | No stickiness |
| | | If a lot is added, coating does not dry due |
| | | to moisturizing effect of glycerin |
| Fatty acid ester of mono-and | Flakes did not dissolve well, | Some flakes stuck to tomato surface and |
| diglycerides | floated on surface | formed segments of a coating |
| Soy lecithin | Did not dissolve well, floated on | Some lecithin attached to tomato surface |
| | surface | and formed a film with small lumps |
| Sucrose esters of fatty acids | Good | Uniform |
| Methyl cellulose | Formed a gel | Relatively uniform coating is obtained, but |
| | | thick |
| Pectin | Good | No stickiness |
| Tween 20 | Good | Uniform (but too little Tween was added |
| | | → no full coverage was obtained) |

Solubility (in water) is a preferred property for the ingredients of the coating formulation. It facilitates dry ingredients to mix and dissolve with a reasonable amount of mechanical force and in a reasonable amount of time. It generates a well-dispersed coating solution with no lumps, and consequently a uniform coating on produce surfaces. It enables the post-harvest treatment to be implemented more smoothly into larger scale processes and equipment.

Since the coating material may be produced by mixing dry ingredients (acidulant, carbohydrate, and emulsifier/stabilizer) into water, it is preferred that the ingredients including emulsifiers/stabilizers are suited for this purpose. Emulsifiers vary largely in their solubility and commercial applications. Generally, they can be characterized using the Hydrophilic Lipophilic Balance (HLB), which gives an indication of emulsifier solubility and performance. The HLB scale varies from 0-20. An emulsifier with a low HLB value is more soluble in oil (and promotes water-in-oil emulsions), while an emulsifier with a high HLB value is more soluble in water (and promotes oil-in-water emulsions). For the purpose of mixing emulsifiers into a water-based coating solution, emulsifiers with a higher HLB value (>7) are preferred, as they will dissolve better. All emulsifiers chosen for this experiment have a medium to high HBL value range.

Dawn® liquid dish soap, vegetable glycerin, sucrose esters of fatty acids, and Tween 20 demonstrated good solubility in the water-based coating solution, whereas soy lecithin, fatty acid ester of mono- and diglycerides, and methyl cellulose did not dissolve as well. Photographs were taken of the coating solutions prepared with a) soy lecithin and b) FA ester of MDG. Both materials have lower HLB values (lecithin 2-7, FA ester of MDG 3-8) and did not dissolve well in the water-based coating solutions. Instead the flakes/particles floated on the more hydrophobic water-air interface. In the coating solution prepared with methyl cellulose, the material dissolved better than lecithin and FA ester of MDG but formed lumps of gel.

To understand the colloidal forces in these three coating solution systems, compared to a coating solution containing Tween 20 or sucrose esters of fatty acids, the chemical structures of the compounds were studied.

Lecithin—is a naturally (animal and plant tissues) occurring mixture of phospholipids, consisting of a glycerol backbone with phosphatidyl groups. Lecithin compounds are usually classified as amphiphilic or zwitterionic due to a hydrophilic part and hydrophobic tails. This makes them excellent surfactants, reducing the surface energy (Gibbs theorem) when adsorbing to water/air or water/oil interfaces. Lecithin is widely used as an emulsifier in food applications such as sauces.

However, for the purpose of this invention, lecithin is less water-soluble than preferred (low HLB value). Since the coating solution does not contain an oil phase (such as emulsions do), the lecithin molecules tend to accumulate at the more hydrophobic water-air interface instead and be of limited value for the produce coating.

Fatty acid ester of mono- and diglycerides—are, similarly to lecithin, a mixture of different compounds. They are produced synthetically from glycerol and natural fatty acids, and are commonly added to commercial food products in small quantities to help emulsify oil and water. However, these molecules were also found to be less water-soluble than preferred. The material accumulated at the more hydrophobic water-air interface.

Methyl cellulose—is a chemical compound derived from cellulose. It consists of numerous linked glucose molecules where hydroxyl groups (—OH) have been substituted with methoxide groups (—OCH₃). In pure form, it is a hydrophilic white powder and dissolves in cold (but not in hot) water, forming a clear viscous solution or gel. It is used as a thickener and emulsifier in various food and cosmetic products.

Preparing a solution of methyl cellulose with cold water can be difficult, however. As the powder comes into contact with water, a gel layer forms around it, slowing the diffusion of water into the powder; hence the inside can remain dry.

Methyl cellulose dissolved better in the coating solution than lecithin or FA ester of MDG, but it formed lumps of gel. Gelling is impractical for larger scale applications and may detract from with the desired uniformity and coating thinness. Consequently, methyl cellulose is not preferred as a substitute for dish soap in the coating formulation. However it has potential for assisting in controlled film forming due to its thickening and stabilizing properties, especially if added in smaller quantities. Thus, it may be an additive in further formulation efforts.

Sucrose ester of fatty acids—is obtained by esterifying sucrose with edible fatty acids. The molecule is very hydrophilic, although, by varying the degree of esterification it is possible to obtain emulsifiers with HLB values ranging from 1 to 16.

Many food manufacturers use sucrose ester as it can for example improve the production process by reducing mixing time or keeping viscosities low. For this invention, sucrose ester functions very well due to its good solubility in water, its high adherence to the tomato surface and its uniform film-forming properties.

Pectin—is a structural heteropolysaccharide, generally recognized as safe (GRAS) and commonly used in foods as gelling agent and thickening agent, primarily in jams and jellies. It is very hydrophilic and therefore dissolves readily in water-based systems. Pectin is used in the formulation of pharmaceutical capsules in combination with other film-forming polymers, such as for example gelatin, and is also used in the research and development of new edible films for food packaging in which pectin is combined with other active and functional ingredients to generate environmentally friendly alternatives to plastic packaging. However, in these formulations, the pectin-containing solutions are usually heated to higher temperatures (for example 50° C. for capsules, 125° C. for films generated by extrusion).

In this invention it is not preferred to heat the coating solution; it is preferred that the ingredients solubilize and function as film-formers at ambient temperature. This experiment showed that pectin alone (or in combination with corn starch), solubilized at room temperature, is not preferred to generate a film on grape tomatoes. However, pectin may still be used as an additional ingredient in the coating formulation and may be further investigated in combination with other biopolymers, emulsifiers, and stabilizers.

Tween 20—is a polysorbate surfactant whose stability allows it to be used as a detergent and emulsifier in a number of applications. It has a high HLB value of 15-17, which indicates good solubility in water. For this invention, Tween 20 has desired solubility.

Table 7 below summarizes the HLB value ranges for the compounds discussed above. It shows clearly, a higher HLB value corresponds to better solubility in water, and consequently preferred properties for the produce coating.

TABLE 7
Overview of the HLB value ranges for lecithin, fatty acid ester
of mono- and diglycerides, methyl cellulose, sucrose esters of
fatty acids, and Tween 20

| | | FA ester | Methyl | Sucrose | |
|---|---|---|---|---|---|
| | Lecithin | of MDG | cellulose | ester of FA | Tween 20 |
| HLB value | 2-7 | 3-8 | 10-12 | 1-16 | 15-17 |
| ranges | | | | | |

Table 8 below summarizes the assessment of the coating solutions and dried coatings for the various emulsifiers/stabilizers. The most promising alternatives to dish soap are sucrose ester of fatty acids and the surfactant Tween 20. Methyl cellulose might be an option as well, especially if gelling is controlled or minimized. Pectin alone did not form a film but might still be considered in combination with other materials. Vegetable glycerin by its own did not generate a coating, but may be used as a plasticizer in further formulation efforts. A plasticizer modifies the three-dimensional organization of polymeric materials, decreasing attractive intermolecular forces and increasing chain mobility, which results in increased extensibility, dispensability, and flexibility of a polymer-based film, while at the same time cohesion and rigidity of the film are decreased. Examples of other food-grade plasticizers are: sorbitol, glucose, sucrose, monoglycerides, phospholipids, and surfactants.

TABLE 8
Overall assessment of emulsifiers in terms of solubility in
coating solution and in terms of generating a uniform
coating on grape tomatoes

| Emulsifier | Solubility | Coating | Overall |
|---|---|---|---|
| Dawn dish soap | Good | Good | Good |
| Vegetable glycerin | Good | Less | Less preferred |
| | | preferred | |
| Fatty acid ester of | Less | Less | Less preferred |
| mono-and diglycerides | preferred | preferred | |
| Soy lecithin | Less | OK | Less preferred |
| | preferred | | |
| Sucrose ester | Good | Good | Good |
| Methyl cellulose | OK | OK | OK (could be used in |
| | | | combination with an |
| | | | additional film-forming |
| | | | polymer) |
| Pectin | Good | Less | Less preferred (maybe |
| | | preferred | in combination with an |
| | | | additional film-forming |
| | | | polymer) |
| Tween 20 | Good | OK | Good |

Mixtures of Emulsifiers

Combinations of two or more emulsifiers were tested to give an indication on whether stickiness and film-forming properties of the coating material can be improved by combining different emulsifying and thickening agents. The combinations tested include: Tween 20+sucrose ester of FA; dish soap+sucrose ester of FA; and mixture of dish soap, xanthan gum, sucrose ester of FA and methyl cellulose.

Photographs were taken of grape tomatoes coated with: Tween 20 (increasing concentration) plus sucrose ester of fatty acids (increasing concentration); and dish soap (increasing concentration) plus sucrose ester of fatty acids (increasing concentration). The photographs demonstrate the hydrophobic properties of the grape tomato surface (whether it is entirely natural or has been additionally treated with oil/wax in the value chain), and how both Tween 20 and dish soap can overcome this hydrophobicity with increasing concentrations. The photographs also show how more uniform coatings are obtained once sucrose ester is successively added to the coating solution.

Another series of photographs were taken. A first photograph showed grape tomatoes coated with only dish soap. Successively more ingredients were added to the coating solution and photographs were taken: first xanthan gum, then sucrose ester of fatty acids, and finally methyl cellulose. The photographs indicated an improvement in coating properties with the successive addition of more emulsifying/stabilizing agents. Dish soap by itself generated a partial coating, while addition of xanthan gum increased the coating's stickiness and coverage. Sucrose ester of fatty acids improved the uniformity and coverage of the film further, and methyl cellulose increased the thickness and coverage even more.

This shows that in some embodiments a combination of different biopolymers and surface-active compounds may result in more preferred coatings than just one biopolymer or surfactant by itself.

Results—Microbial Evaluation

The following coatings were evaluated microbiologically: Dawn® liquid dish soap (control), Tween 20, and sucrose ester of fatty acids.

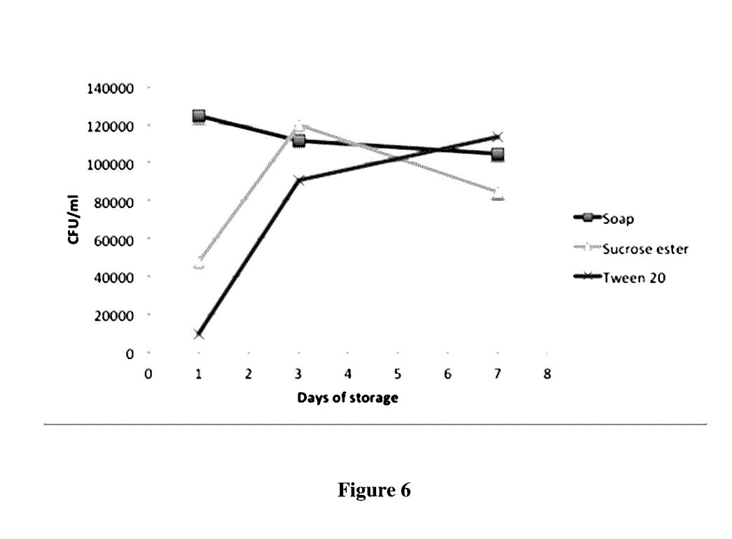

FIG. 6 attached illustrates the microbial load on grape tomatoes coated with these three different coating materials. The swabs collected after 1 day of storage showed a significant difference in CFU/ml between the coating with soap and the other two coatings. However, the swabs after 3 days and 7 days of storage show a very similar microbial load. This indicates that over a longer storage time, there is no difference between a coating containing dish soap, and a coating where dish soap has been exchanged against sucrose ester of FA or Tween 20.

Photographs were taken of plates containing swabs from grape tomatoes without coating, and grape tomatoes coated with dish soap, with sucrose ester fatty acids, and with Tween 20. The swabs were collected after 1 day of storage and the plates photographed after 2 days of incubation. Photos were taken of the same plates but after 7 days of incubation. The photos demonstrate clearly the antimicrobial effect of the three different coatings in comparison to the non-coated control sample, as all three coatings inhibited growth of naturally occurring microorganisms while the non-coated control sample displays numerous visible colonies.

Similarly, photographs were taken of plates containing swabs from non-coated tomatoes and tomatoes with the three different coatings, swabbed after 3 days of storage and photographed after 2 days and 7 days of incubation respectively. The photos again demonstrate the antimicrobial properties and inhibitory effect of the three coatings on naturally occurring microorganisms.

Additional photographs were taken of plates containing swabs from non-coated and coated tomato samples, swabbed after 7 days of storage. They indicate the same trends.

Conclusions

Coatings with sucrose ester of fatty acids were preferred in the coating formulation both in terms of the material's solubility in water, its adhesion to grape tomatoes, its uniform film-forming properties, and the coating's antimicrobial properties.

Tween 20 was also preferred as substitute for dish soap without changing coating quality or its antimicrobial properties.

Although some emulsifying/stabilizing agents were less preferred film-formers on their own, experiments indicate that combinations of these materials may be beneficial to coating quality and stability.

### Experiment 3

Shelf Life/Quality

Additional experiments were done comparing cantaloupes and grape tomatoes that were coated with the post-harvest coating of the invention against those that were left uncoated (“control”). The produce was stored at ambient temperature. Cantaloupes were photographed after 1 day, 5 days, 7 days, and 9 days; and tomatoes were photographed after 1 day, 5 days, 7 days, 9 days, and 11 days. After 9 days, the coated cantaloupes had much better shelf life/quality than the uncoated ones. Also, after 11 days, the coated tomatoes had much better shelf life/quality than the uncoated ones.

Sensory

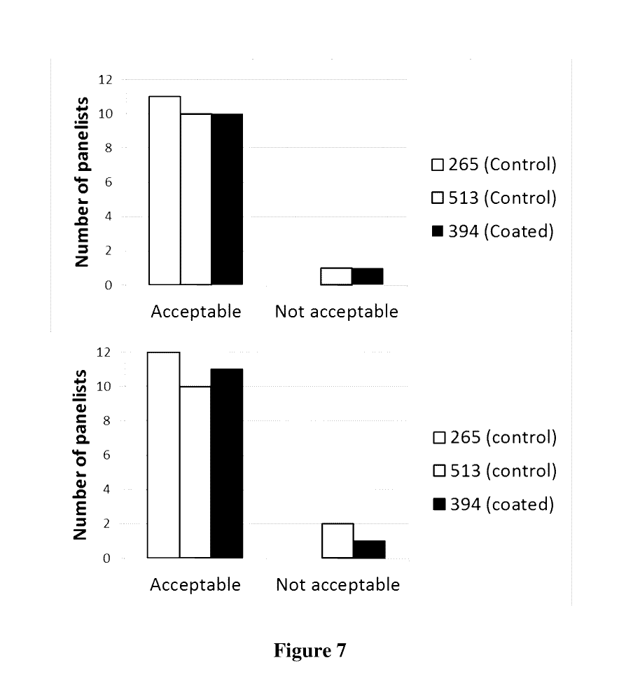

A sensory panel was not able to taste a difference in tartness, sweetness and off-flavors between coated and non-treated samples. Also, there was no difference in the overall acceptability between coated and non-treated samples. The results are shown graphically in FIG. 7 attached.

Inhibition Zones

Filter paper disks were treated with the coating and applied onto agar plates inoculated with microorganisms which were collected from tomatoes and cantaloupes. The coating generated inhibition zones around the disks as a direct result of its inhibitory effect on the growth of microorganisms. The coating showed effectiveness against various molds and bacteria as well as against spores. The following Table 10 shows measurements of the inhibition zones:

TABLE 10
Measurements of Inhibition Zones of Bacteria, Molds and Spores

| Sample | | Inhibition zone diameters | Average | |
|---|---|---|---|---|
| Tomato | Bacteria | 0.72-1.30 | 0.83 | 0.794 |
| Cantaloupe | Bacteria | 0.55-0.99 | 0.76 | |
| Tomato | Mold | 0.55-0.90 | 0.78 | 0.786 |
| Cantaloupe | Mold | 0.59-1.00 | 0.80 | |

| | | |
|---|---|---|
| Spores | 0.55-0.90 | 0.725 |
| Control | 0.350 | 0.350 |
| (Non-treated paper disk) | | |

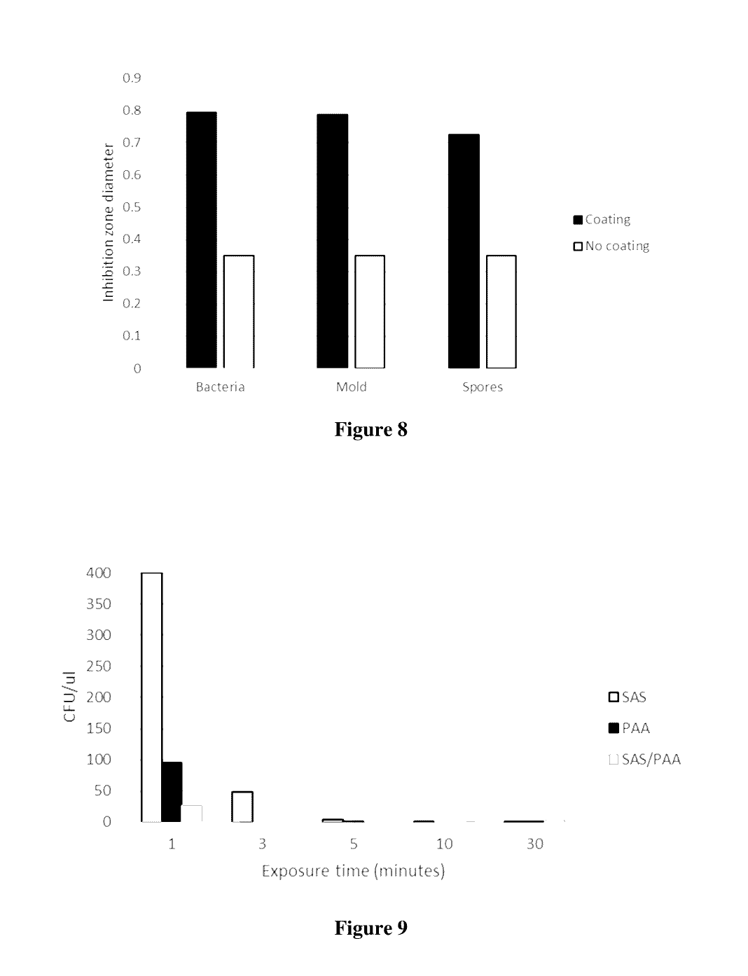

The results are shown graphically in FIG. 8 attached.

The inhibition zone around the filter paper disks consists of two distinct rings, an inner ring and an outer ring. The inner ring shows no growth and demonstrates the coating's ability to inhibit the germination of spores. With increasing distance from the coating disks the inhibitory effect of the coating material gradually decreases. Consequently, the outer ring contains some growth but no new spore production. This demonstrates the coating's ability to not only inhibit the germination of spores, but also to slow down both the vegetative cycle and the sporulation process (generation of new spores).

FIG. 9 attached shows the inactivation of spores by three coating solutions (SAS, PAA, and SAS/PAA) over an exposure time frame of 30 minutes. The coatings containing peracetic acid (PAA) show a rapid inactivation within 1 minute. The coating containing only sodium acid sulfate (SAS) needs slightly longer but achieves after 5 minutes of exposure the same level of spore inactivation as peracetic acid. A combination of sodium acid sulfate and peracetic acid accelerates the inactivation of spores.

Inhibition of Salmonella

The following Table 11 shows measurements of the inhibition zones of Salmonella using the coating of the invention:

TABLE 11
Measurements of Inhibition Zones of Salmonella

| Sample | Inhibition zone diameter | Average |
|---|---|---|
| Salmonella | 0.79-0.94 | 0.81 |
| Control (Non-treated paper disk) | 0.350 | 0.350 |

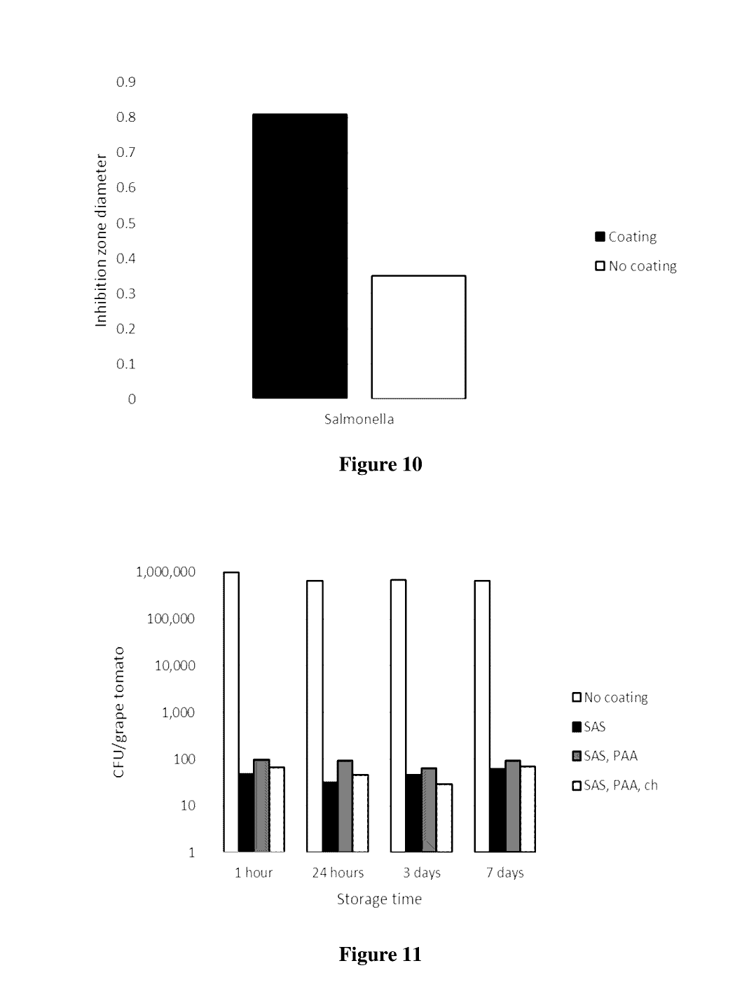

The results are shown graphically in FIG. 10 attached.

Supplementing SAS with Peracetic Acid and Chitosan

Additional experimental data show that the coating containing sodium acid sulfate (SAS) can be supplemented with further antimicrobial ingredients such as peracetic acid (PAA) and chitosan (ch), while achieving a similar inhibitory effect on naturally occurring microorganisms.

The results are shown graphically in FIG. 11 attached.

What is claimed is:

1. An antimicrobial coating material for post-harvest coating of produce comprising a mixture of:
an acid component; and
a film-forming carbohydrate.

2. The coating material of claim 1 wherein the acid component comprises a bisulfate.

3. The coating material of claim 2 wherein the acid component comprises sodium acid sulfate.

4. The coating material of claim 1 wherein the film-forming carbohydrate comprises a plant starch.

5. The coating material of claim 4 wherein the film-forming carbohydrate comprises cornstarch.

6. The coating material of claim 1 which further comprises a surfactant/emulsifier.

7. The coating material of claim 6 which comprises the acid component in an amount from about 1% to about 15% by weight, the film-forming carbohydrate in an amount from about 1% to about 20% by weight and the surfactant/emulsifier in an amount from about 0.001% to about 5% by weight.

8. The coating material of claim 1 which further comprises water and wherein the coating material is an aqueous solution of the acid component and the film-forming carbohydrate.

9. The coating material of claim 1 which is in the form of an encapsulating film on the produce and which functions as a protective pH-lowering coating.

10. A method for post-harvest treatment of produce comprising:
applying a coating material onto produce after harvest and cleaning, thereby producing an antimicrobial coating in the form of an encapsulating film on the surface of the produce;
the coating material comprising a mixture of an acid component and a film-forming carbohydrate.

11. The method of claim 10 wherein the coating material is applied to freshly harvested produce.

12. The method of claim 10 wherein the coating material further comprises water and wherein the coating material is an aqueous solution of the acid component and the film-forming carbohydrate.

13. The method of claim 12 wherein the coating material is applied by soaking, dipping or spraying the produce.

14. The method of claim 10 wherein the applied coating reduces the amount of microorganisms on the surface of the treated produce.

15. The method of claim 14 wherein the applied coating reduces spoilage of the treated produce.

16. The method of claim 10 wherein the applied coating adheres to the surface of the produce and is stable enough to remain intact on the surface for at least several days.

17. The method of claim 10 wherein the acid component comprises sodium acid sulfate.

18. A method for inactivating microbial spores on produce comprising:
applying a coating material onto produce after harvest and cleaning, thereby producing an antimicrobial coating in the form of an encapsulating film on the surface of the produce, the coating material being effective to inactivate microbial spores on the produce;
the coating material comprising a mixture of an acid component and a film-forming carbohydrate.

19. The method of claim 18 wherein the coating material is effective to inhibit germination of spores, vegetative cycle of spores, and sporulation.

20. The method of claim 18 wherein the coating material is effective to inactivate the spores within about 5 minutes of coating the produce.
